(19) United States
(12) Patent Application Publication
(10) Pub. No.: US 2018/0060743 A1
(43) Pub. Date: Mar. 1, 2018

(54) Electronic Book Reader with Supplemental Marginal Display

(71) Applicant: Google Inc., Mountain View, CA (US)

(72) Inventors: Daniel Chak, San Francisco, CA (US); Vikas Vadlapatla, San Francisco, CA (US)

(21) Appl. No.: 15/252,836

(22) Filed: Aug. 31, 2016

(51) Int. Cl. G06N 5/04; G06N 99/00; G06F 3/14

(52) U.S. Cl. CPC G06N 5/04; G06T 13/80; G06F 3/14; G06N 99/005

(57) ABSTRACT

Digital content is received and supplemental content metadata is produced. The supplemental content metadata indicates a location of a feature in the digital content that is predicted to be of interest to a user. A digital content package is created that includes the digital content and the supplemental content metadata. The digital content package is provided to an electronic device, which presents the digital content in conjunction with a notification that a current position in the digital content is approaching the location of the feature.

### BACKGROUND

### 1. Technical Field

The subject matter described herein generally relates to electronic book readers, and in particular to displaying supplemental content in a margin to improve the user experience.

### 2. Background Information

Electronic books (“ebooks”) come in a variety of formats, such as the International Digital Publishing Forum's electronic publication (EPUB) standard and the Portable Document Format (PDF). Ebooks can be read using a variety of devices, such as dedicated reading devices, general-purpose mobile devices, tablet computers, laptop computers, and desktop computers. Each device includes reading software (an “ereader”) that displays an ebook to a user.

Users often stop reading ebooks before reaching the end. In the case of a novel, the user may have found the current chapter boring. With a textbook (or other informational book), the user might have determined that the content is either too simplistic or too complex, and thus of little value. However, by giving up before the end of a book, users often miss out on later content that they would have found enjoyable or useful.

### SUMMARY

The above and other problems are addressed by a system, a method, and a non-transitory computer-readable storage medium. In one embodiment, the method includes receiving digital content and producing supplemental content metadata indicating a location of a feature in the digital content that is predicted to be of interest to a user. The method also includes creating a digital content package including the digital content and the supplemental content metadata. The method further includes providing the digital content package to an electronic device for presentation of the digital content in conjunction with a notification that a current position in the digital content is approaching the location of the feature.

In one embodiment, the system includes a non-transitory computer-readable storage medium storing executable computer program code and one or more processors for executing the code. The executable computer program code includes instructions for receiving digital content and producing supplemental content metadata indicating a location of a feature in the digital content that is predicted to be of interest to a user. The executable computer program code also includes instructions for creating a digital content package including the digital content and the supplemental content metadata. The executable computer program code further includes instructions for providing the digital content package to an electronic device for presentation of the digital content in conjunction with a notification that a current position in the digital content is approaching the location of the feature.

In one embodiment, the non-transitory computer-readable storage medium stores executable computer program code including instructions for receiving digital content and producing supplemental content metadata indicating a location of a feature in the digital content that is predicted to be of interest to a user. The executable computer program code also includes instructions for creating a digital content package including the digital content and the supplemental content metadata. The executable computer program code further includes instructions for providing the digital content package to an electronic device for presentation of the digital content in conjunction with a notification that a current position in the digital content is approaching the location of the feature.

### BRIEF DESCRIPTION OF THE DRAWINGS

FIG. 1 is a high-level block diagram illustrating a networked computing environment suitable for providing ebooks and supplemental content for marginal display, according to one embodiment.

FIG. 2 is a high-level block diagram illustrating an example of a computer for use in the networked computing environment of FIG. 1, according to one embodiment.

FIG. 3 is a high-level block diagram illustrating one embodiment of the ebook corpus shown in FIG. 1.

FIG. 4 is a high-level block diagram illustrating one embodiment of the ebook analysis system shown in FIG. 1.

FIG. 5 is a high-level block diagram illustrating one embodiment of the ebook distribution system shown in FIG. 1.

FIG. 6 is a high-level block diagram illustrating one embodiment of a reader device shown in FIG. 1.

FIG. 7 is a flowchart illustrating a method of providing ebook content and supplemental content metadata to a reader device, according to one embodiment.

### DETAILED DESCRIPTION

Publishers are making an increasing volume of content available digitally at the time of publication. There is also a vast corpus of print books available that are regularly scanned after publication creating additional electronic content. Digital content can include a variety of content types, including text, images, equations, audio clips, and videos. For convenience, the term “ebook” is used herein to refer to any collection of digital content with a defined order or layout. However, note that some digital content is designed to be consumed in multiple orders (e.g., choose your own adventure books), while others include sections or chapters designed to be experienced separately (e.g., a user may jump straight to the pertinent section in a reference book).

Just as with print books, people often stop reading an ebook before completing it. Consequently, people miss out on content from later in the ebook that they would have enjoyed or found useful. However, technology provides opportunities to address this problem. Just as someone trying to exercise more can benefit from a coach saying “just one more lap and you're done,” readers can benefit from signposts that point them toward their next reading milestone. For example, knowing that a favorite character or pivotal scene is imminent may encourage them to persevere through a section they find less interesting. Alternatively, readers may even skip ahead to a more interesting portion. For example, in the case of a text book, a reader might want to jump straight to a problem set if the subject matter of the chapter seems straightforward.

Print books often provide a contents page that indicates on which page chapters or sections begin. However, this structure is linear, static, and provides little contextual information to aid with reader engagement. Technology allows for much more nuanced structure to be conveniently determined, such as the location of features including specific characters, plot elements, themes, locations, scene types, locations, and the like. This structure enables an ebook reader to reveal information (supplemental content) about upcoming book content that builds anticipation and encourages the reader to continue. In some instances, the revealed information can be tailored to the reader. For example, if character A is a favorite of reader X, but reader Y prefers character B, a notification that a scene with character A is imminent would be of interest to X but possibly not Y.

In addition, reading devices designed to be portable often trade off screen size with ease of carrying. Thus, many reading devices have relatively small screens. Making efficient use of screen real-estate provides value to such individuals. For example, if supplemental content is presented partially or entirely in a margin that would otherwise remain blank, the screen area available for display of the ebook content is not impacted.

### System Overview

The Figures (FIGS.) and the following description describe certain embodiments by way of illustration only. One skilled in the art will readily recognize alternative embodiments of the structures and methods that may be employed without departing from the principles described. Where convenient, similar or like reference numbers are used in the figures to indicate similar or like functionality.

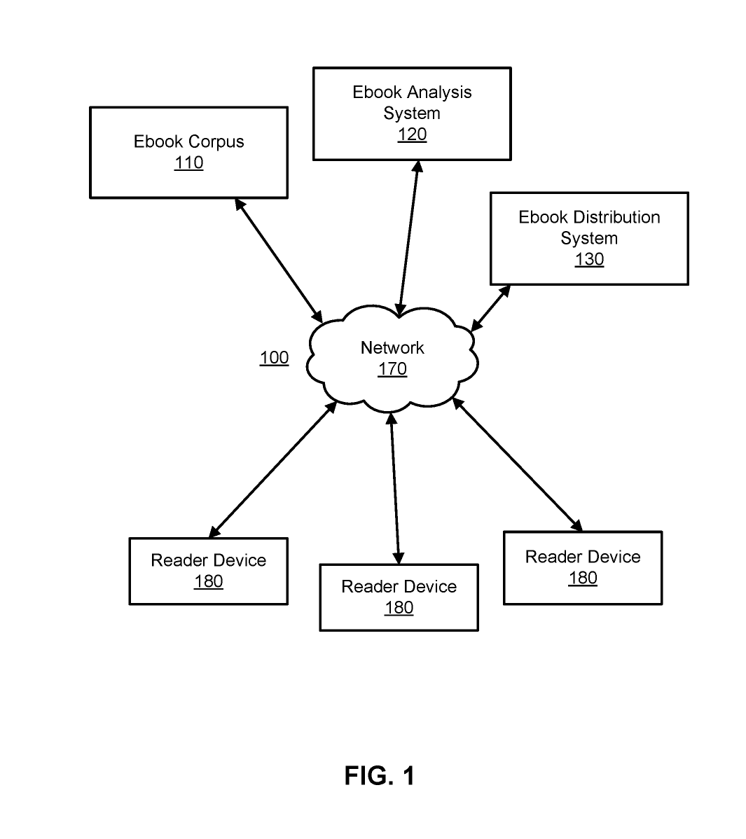

FIG. 1 illustrates one embodiment of a networked computing environment 100 suitable for providing ebooks and corresponding supplemental content for marginal display in conjunction with the ebook. As shown, the environment 100 includes an ebook corpus 110, an ebook analysis system 120, an ebook distribution system 130, and several reader devices 180, all connected via a network 170. Other embodiments of the networked computing environment 100 include different or additional components. In addition, the functions may be distributed among the components in a different manner than described herein. For example, although the ebook corpus 110, ebook analysis system 120, and ebook distribution system 130 are shown as separate components, in some embodiments the corresponding functionality is provided by a single server or server farm.

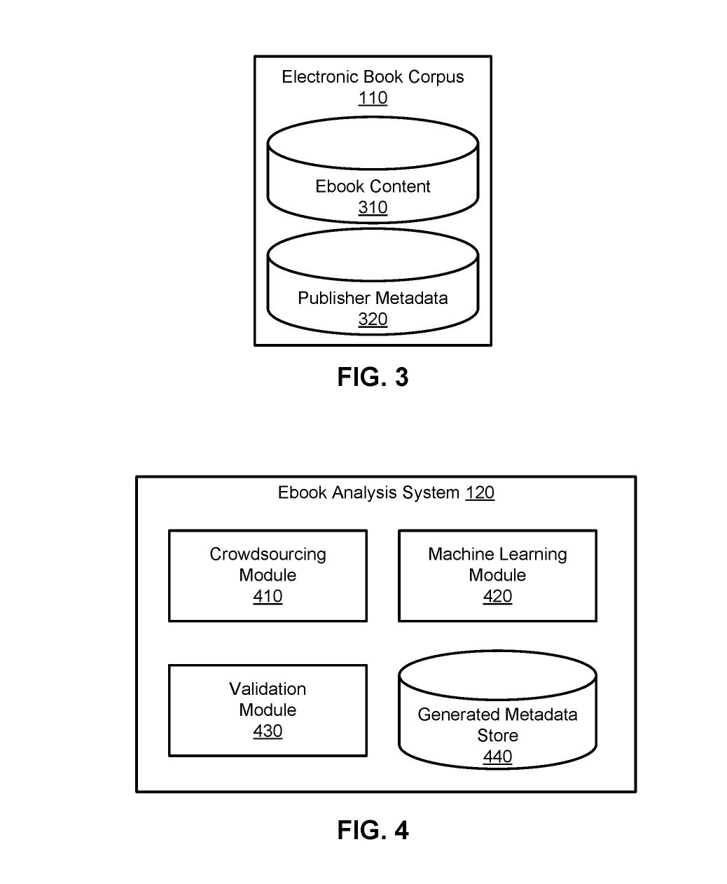

The ebook corpus 110 stores digital representations of books. The digital representations can use any appropriate format, such as EPUB or PDF. In various embodiments, the digital representations are provided pre-made by publishers and authors, created by scanning existing printed books, or compiled using a combination of these techniques. The ebook corpus 110 is described in detail below, with reference to FIG. 3.

The ebook analysis system 120 generates metadata indicating the location of features within an ebook. In one embodiment, the ebook analysis system 120 uses crowdsourcing to solicit the locations of features. In another embodiment, the ebook analysis system 120 applies a machine learning model for this purpose. In other embodiments, combinations of these techniques or alternative techniques are used. In some instances, the identification of certain features of an ebook is used to assist in the identification of others. For example, in one embodiment, if the ebook analysis system 120 determines a particular ebook contains one character, this is increases the likelihood that it also mentions related characters, concepts, locations, and the like. The ebook analysis system 120 is described in detail below, with reference to FIG. 4.

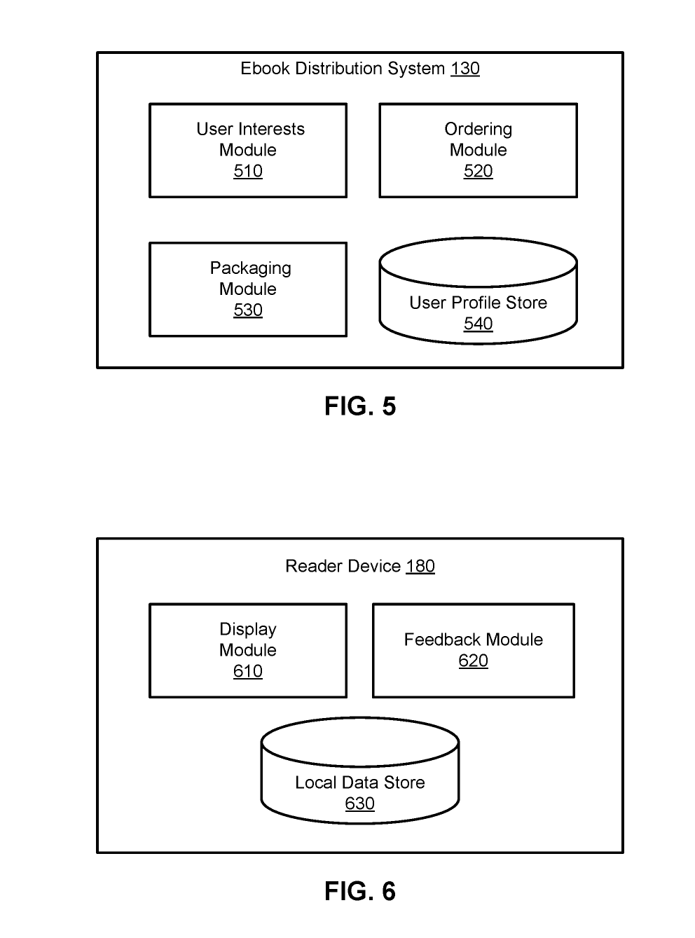

The ebook distribution system 130 creates packaged ebooks that include ebook content from the corpus 110 and metadata indicating the location of features. The metadata is used to determine what supplemental content to display in conjunction with the ebook. In one embodiment, the metadata is customized to the user that is downloading the packaged ebook. The metadata identifies the location of features likely to be of interest to the user, which can then be used by the reader device 180 to generate supplemental content to display in conjunction with the ebook. For example, based on the user's profile, the metadata might include the locations at which the user's favorite characters are mentioned but omit the locations of other characters. In another embodiment, the metadata includes instructions on specific supplemental content to display at pre-determined locations. For example, the metadata might instruct the reader device 180 to display a note in the margin notifying the user an event of interest is upcoming three pages before a favorite character makes a return. In a further embodiment, the metadata identifies the location of all (or a significant proportion) of the features identified by the ebook analysis system 120. This metadata is then further processed at the reader devices 180 of individual users to identify the features that are likely to be of interest to that user. The ebook distribution system 130 is described in detail below, with reference to FIG. 5.

The reader devices 180 can be any computing device capable of presenting an ebook to a user, such as desktop PCs, laptops, smartphones, tablets, dedicated reading devices, and the like. Although only three reader devices 180 are shown, in practice there are many (e.g., millions of) reader devices 180 that can communicate with the other components of the environment 100 using the network 170. In one embodiment, a client device 180 receives a packaged ebook from the ebook distribution system 130 and presents it to a user along with supplemental marginal content based on the included metadata. In another embodiment, the client device 180 also provides feedback controls to enable the user to indicate whether the supplemental content was of interest or not. An exemplary reader device 180 is described in detail below, with reference to FIG. 6.

The network 170 enables the components of the networked computing environment 100 to communicate with each other. In one embodiment, the network 170 uses standard communications technologies and/or protocols and can include the Internet. Thus, the network 170 can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 170 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), etc. The data exchanged over the network 110 can be represented using technologies and/or formats including image data in binary form (e.g. Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities on the network 170 can use custom and/or dedicated data communications technologies instead of, or in addition to, the ones described above.

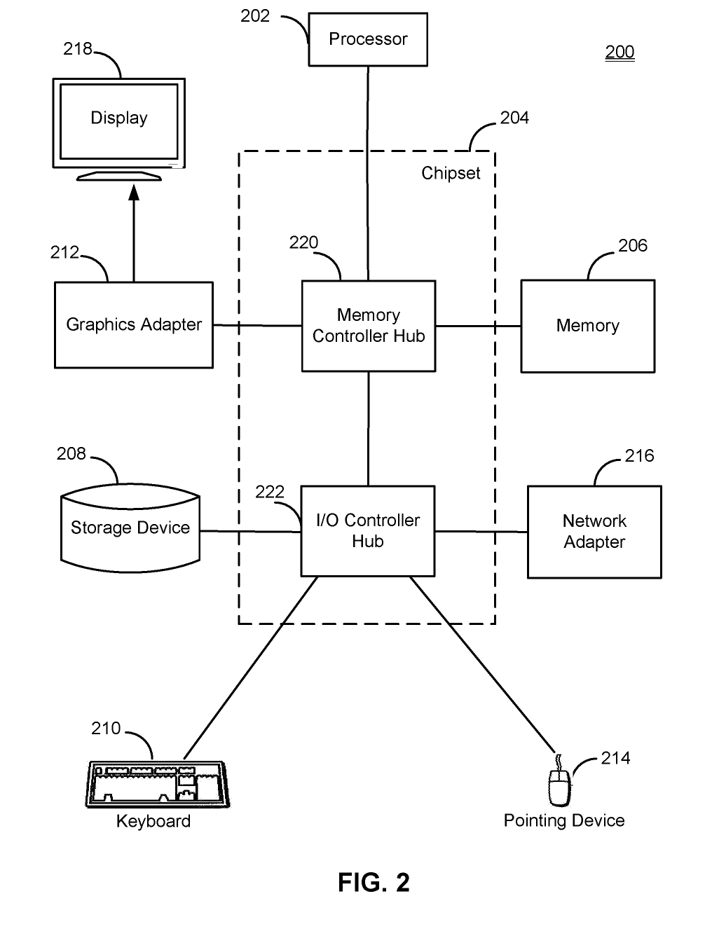

FIG. 2 is a high-level block diagram illustrating one embodiment of a computer 200 suitable for use in the networked computing environment 100. Illustrated are at least one processor 202 coupled to a chipset 204. The chipset 204 includes a memory controller hub 250 and an input/output (I/O) controller hub 255. A memory 206 and a graphics adapter 213 are coupled to the memory controller hub 250, and a display device 218 is coupled to the graphics adapter 213. A storage device 208, keyboard 210, pointing device 214, and network adapter 216 are coupled to the I/O controller hub 255. Other embodiments of the computer 200 have different architectures. For example, the memory 206 is directly coupled to the processor 202 in some embodiments.

The storage device 208 includes one or more non-transitory computer-readable storage media such as a hard drive, compact disk read-only memory (CD-ROM), DVD, or a solid-state memory device. The memory 206 holds instructions and data used by the processor 202. In one embodiment, program modules formed of executable computer program instructions are stored on the storage device 208, loaded into the memory 206, and executed by the processor 202.

The pointing device 214 is used in combination with the keyboard 210 to input data into the computer system 200. The graphics adapter 213 displays images and other information on the display device 218. In some embodiments, the display device 218 includes a touch screen capability for receiving user input and selections. The network adapter 216 couples the computer system 200 to the network 110. Some embodiments of the computer 200 have different or additional components than those shown in FIG. 2. For example, the ebook analysis system 120 can be formed of multiple computers 200 operating together to provide the functions described herein. As another example, the client device 180 can be a smartphone and include a touch-screen that provides on-screen keyboard 210 and pointing device 214 functionality.

### Exemplary Systems

FIG. 3 illustrates one embodiment of the ebook corpus 110. As shown, the ebook corpus 110 includes ebook content 310 and publisher metadata 320. Other embodiments of the ebook corpus 110 include different or additional components. For example, although the ebook content 310 and publisher metadata 320 are shown as distinct entities, a single data store may be used for both the content and metadata.

The ebook content 310 stores the text, illustrations, and other content that is included on books in the corpus 110, and is stored on one or more non-transitory computer-readable storage media. As described previously, the ebook content 310 can be provided directly by publishers and authors or obtained by scanning existing printed books. In one embodiment, the ebook content 310 includes PDF documents of complete books, with each page of the PDF including an image of a page of the book. Alternatively, each page of the PDF may include more or less than a page in the book, such as a two-page spread or an illustration taken from part of a page. In another embodiment, the ebook content 310 is stored as EPUB files. One of skill in the art will appreciate other formats in which ebook content 310 can be stored.

The publisher metadata 320 is metadata provided by ebook publishers or authors that includes information about the ebook, such as title, publication date, author, publisher, series, main characters, page numbers on which chapters begin, and the like. In embodiments where the ebook content 320 is generated by scanning existing printed books, there may be no publisher metadata. Alternatively, the individual or entity that scans the printed book can provide publisher metadata 320 (e.g., by typing it into an electronic form as part of the scanning process).

FIG. 4 illustrates one embodiment of the ebook analysis system 120. As shown, the ebook analysis system 120 includes a crowdsourcing module 410, a machine learning module 420, a validation module 430, and a generated metadata store 440. Other embodiments of the ebook analysis system 120 include different or additional components. In addition, the functions may be distributed among the components in a different manner than described herein. For example, the ebook analysis system 120 might not include a generated metadata store 440, instead adding the metadata to the ebook corpus 110 (e.g., by including it directly in an EPUB file). As another example, in embodiments that use crowd-sourced feedback, some or all of the functionality attributed to the validation module 430 may be provided by the feedback modules 620 of user devices 180.

The crowdsourcing module 410 generates metadata indicating the location of features within an ebook based on crowd-sourced data. In one embodiment, the crowdsourcing module 410 receives the crowd-sourced data as feature identification objects from reader devices 180. The feature identification objects are created based on user input and include a name of the feature (e.g., a character's name, a place name, a specific plot theme, a specific scene type, etc.), a type of the feature (e.g., character, location, plot theme, scene type, etc.), a start location (e.g., page and line number, number of words from the beginning of the book, page number and x-y coordinates, etc.), and an end location (e.g., page and line number, number of words from the beginning of the book, page number and x-y coordinates, etc.). Examples of how users may be prompted to provide this information are described below, with reference to FIG. 6.

The crowdsourcing module 410 aggregates the crowd-sourced data to determine the likely location of features in the ebook. In various embodiments, the crowdsourcing module 410 determines a feature is present if the number of received feature identification objects indicating a particular feature is present at the same location (within a degree of tolerance) exceeds a threshold. In one such embodiment, the threshold is a pre-determined number of feature identification objects, such as ten. In another such embodiment, the threshold is defined relative to the total number of feature identification objects corresponding to the location. In another embodiment, a combination of both approaches is used. For example, a quorum of at least two votes and a threshold proportion of 75% might be used. Thus, if two feature identification objects are received, the quorum is not met and no feature is identified. If three feature identification objects are received, all three must indicate the same feature, because two thirds is less than the 75% threshold. If four are received, three being in agreement is sufficient, as this meets the 75% threshold, and so on.

The degree of tolerance is selected to account for different users identifying the same feature but identifying slightly different locations. For example, in a romance novel, one user might identify a romantic encounter between the two main characters (X and Y) as starting on page twelve, line nine, whereas another might enter page twelve, line seven. This input from the users indicates the features character X, character Y, and romantic scene are present at that location. In one such embodiment, the crowdsourcing module 410 determines the location of the features as the average of the indicated locations. Thus, in the previous example, the features would begin at page nine, line eight. In other embodiments, users indicate the paragraphs or pages on which features are present. Where the users do this in versions with different pagination (e.g., due to different screen or font sizes), these fuzzy locations can be aggregated to determine the location of a feature with greater accuracy. Regardless of the precise method used, once the crowdsourcing module 410 determines that a feature is present above a required threshold, it generates metadata indicating the identity and location of the feature (e.g., in the generated metadata store 440).

The machine learning module 420 builds a machine-learning model from a training set of ebooks. When applied to ebook content, the model predicts features that are included therein. In one embodiment, the machine learning module 420 selects a subset of ebooks from the corpus 110 randomly to use as the training set. In other embodiments, the subset is based on publisher metadata 320. For example, the machine learning module 420 may select the subset to include a range of values for one or more features (e.g., authors, publishers, scene types, characters, etc.) to increase the probability that the initial model will accurately identify those features in an unknown ebook. In one such embodiment, publisher metadata 320 is used to group ebooks by genre, and the subset is populated by randomly selecting a given number of ebooks from each group. In a further embodiment, the training set is selected manually and provided to the machine learning module 420. In yet another embodiment, the training data is crowd-sourced from participating users, and thus the training set is those ebooks from the corpus 110 that participating users choose to read during a training phase.

The machine learning module 420 prepares the training set for use in a training phase. In various embodiments where the corpus 110 is at least populated by scanned print books, the machine learning module 420 processes the scanned images to prepare them for use in the training phase. In one embodiment, the machine learning module 420 extracts raw images (e.g., corresponding to individual pages) from ebooks in the training set and applies an optical character recognition (“OCR”) algorithm to identify words. In other embodiments, the machine learning module 420 applies additional processing, such as resizing tilt correction, auto-contrasting, normalizing to a uniform average brightness, performing automatic color balancing, and the like, to make application of the OCR algorithm more reliable.

However the training set is prepared, the machine learning module 420 uses it to build an initial feature-identification model. In one set of embodiments, the machine learning module 420 builds the initial model in a supervised training phase. In one such embodiment, human operators read at least a portion of an ebook and indicate the name, type, start location, and end location of specific types of features. For example, an operator might enter a name and type of a feature using a keyboard and identify a range of text corresponding to the feature by tapping or clicking on start and end locations. In another embodiment, the operators select features from a closed set (e.g., from drop-down lists of feature types and names). Regardless of the precise methodology used, the result is a set of ranges of ebook content (e.g., as defined by start and end locations) and metadata identifying one or more features of each range. Note that in some embodiments, only the start of a range is explicitly identified and either no end point or an “artificial” end point is used, such as a certain number of words, pages, or sentences later.

The machine learning module 420 builds the initial model based on the set of ranges and corresponding metadata. In some embodiments, the model is an artificial neural network made up of a set of nodes in one or more layers. Each node is configured to predict whether a given feature is present in input ebook content, with nodes in each layer corresponding to lower-levels of abstraction than nodes in the preceding layer. For example, a node in the first layer might determine a character is mentioned, a node in the second layer might identify the gender of the character, and a node in the third layer might identify the identity of the character. Similarly, a first-layer node might determine the presence of an interaction between characters, a second-layer node might determine the identity of the interacting characters, and a third-layer node might determine the nature of the interaction (e.g., romantic, friendly, professional, hostile, or the like.). In one embodiment, the publisher metadata 320 is also used in building the model. For example, the presence of a particular character in a thriller makes it more likely for another character created by the same author to also be mentioned rather than another author's character. In other embodiments, other types of model are used, such as graphical models. One of skill in the art may recognize other types of model that can be built from a series of images and paired metadata to predict features of other images.

In various embodiments, the machine learning module 420 builds the initial model using a two-stage process. In the first stage, the input ebook content is passed through a neural network that identifies a fixed number (e.g., one hundred) of ranges that are candidates for including features of interest. In the second stage, the identified ranges are passed through a second neural network that generates a prediction of the identity of the feature and a corresponding probability that the prediction is correct. The machine learning module 420 then calculates the cost of transforming the predicted feature set into the human-identified feature set for the input ebook content.

In some such embodiments, there are two ways in which a given predicted feature in the set can differ from the human-identified feature set: incorrect identity and incorrect location. An incorrect identity is a discrepancy between the identity of the predicted feature and what is included in the human-identified feature set. To give a simple (but extreme) example, if the neural network prediction indicates that Character X is present in a passage of text, but the human-identified feature set includes only Characters Y and Z, it can be inferred that the prediction is incorrect. This might occur where a character is referred to only by a first name, last name, or nick name, or even just a pronoun. Where the human-identified feature set indicates that a feature was incorrectly included in the predicted feature set, the machine learning module 420 removes it from the predicted feature set. As a result, there is a relatively large contribution to transformation cost, because a feature is entirely removed from the feature set. In one embodiment, the cost of adding or removing a feature from the set is a predetermined value based on the type of feature. For example, removing a character might have a first cost associated with it, while removing a location might have a second cost, and removing a plot element a third, etc.

If the incorrect feature was the result if misidentifying a feature, then there will also be a relatively large contribution to the transformation cost corresponding to adding the correct feature to the feature set. However, this cost may be less than completely adding or removing a feature, because some elements may be identical between the feature's true identify and the incorrect prediction (e.g., both may be characters, both may be female, both may be detectives, etc.). In addition, there is a cost associated with bringing a prediction with less than 100% certainty in-line with the confirmation provided by a human identifying that feature as being present. To give an example, the predicted and human-identified feature sets might both include Character X. However, if the prediction was only 70% certain, there is still a transformation cost associated with bringing that prediction up to certainty (i.e., confirming it is correct). In one embodiment, the transformation cost in such a case is the required change in certainty multiplied by the cost of adding the feature were it entirely absent. Thus, in the previous example, the cost would be (100%−70%)×cost of adding Character X.

An incorrect location indicates that the predicted feature is present in the human-identified feature set, but the human provided a different location. In one embodiment, the machine learning module 420 ignores incorrect locations up to a threshold size (e.g., a predetermined number of words difference) and applies a transformation cost that increases exponentially with distance above that threshold. In another embodiment, the machine learning module 420 associates features with one or more contextually identifiable portions of the ebook (e.g., paragraphs, pages, etc.). A predetermined transformation cost is then applied for each such portion that needs to be added or removed from the beginning and end of the range predicted to include the feature to bring the prediction into agreement with the human-identified feature set. For example, if the prediction indicates that a feature is present in paragraphs two and three of a page, but a human indicates it is present in paragraphs one and two, the cost for two paragraphs is incurred (one for removing paragraph three from the range and another for adding paragraph one). One of skill in the art will recognize other ways of determining the transformation cost associated with an incorrect prediction of the location of a feature.

In one embodiment, regardless of the precise method used to determine the transformation cost, the machine learning module 420 applies a backpropagation algorithm to update the model. The algorithm propagates the cost information through the neural network and adjusts node weightings to reduce the cost associated with a future attempt to identify the features of the input ebook content. In one embodiment, the machine learning module 420 applies a gradient descent method to iteratively adjust the weightings applied to each node such that the cost is minimized. The weighting of a node is adjusted by a small amount and the resulting reduction (or increase) in the transformation cost is used to calculate the gradient of the cost function (i.e., the rate at which the cost changes with respect to the weighting of the node). The training module 410 then further adjusts the weighting of the node in the direction indicated by the gradient until a local minimum is found (indicated by an inflection point in the cost function where the gradient changes direction). In other words, the node weightings are adjusted such that the neural network learns to generate more accurate predictions over time.

In another set of embodiments, some or all of the initial model is built from publisher metadata 320. In one such embodiment, the training set includes ebooks that already include publisher metadata identifying certain features, such as characters, authors, plot themes, scene types, and the like. Thus, the machine learning module 420 can build a model from the publisher metadata that can be applied to ebooks that do not include publisher metadata 320 identifying the features of interest, such as those produced by scanning printed books.

The machine learning module 420 applies the trained machine-learned model to ebooks from the corpus 110 that were not part of the training set. The model generates a prediction of the features included in these ebooks. In one embodiment, the machine learning module 420 provides the content of an ebook (e.g., the text of the ebook or a portion thereof) as input to the neural network. Starting at the first layer, nodes receive input data based on the input content. Each node analyzes the input data it receives and determines whether the feature it detects is likely present in the input. On determining the feature is present, the node activates. An activated node modifies the input data based on the activated node's weighting and sends the modified input data to one or more nodes in the next layer of the neural network. If an end node in the neural network is activated, the neural network outputs a prediction that the feature corresponding to that end node is present in the input. In a related embodiment, the prediction is assigned a percentage likelihood that it is correct based on the weightings assigned to each node along the path taken through the neural network.

Regardless of the precise method used to make the predictions, the machine learning module 420 generates metadata indicating the identity and location of the predicted features. In one embodiment, similar to the metadata created by the crowdsourcing module 410, this metadata includes a name of the feature (e.g., a character's name, a place name, a specific plot theme, a specific scene type, etc.), a type of the feature (e.g., character, location, plot theme, scene type, etc.), a start location (e.g., page and line number, number of words from the beginning of the book, page number and x-y coordinates, etc.), and an end location (e.g., page and line number, number of words from the beginning of the book, page number and x-y coordinates, etc.). The machine learning module 420 then stores the generated metadata (e.g., in the generated metadata store 440).

The validation model 430 presents the features generated for ebooks by the crowdsourcing module 410 or the machine learning module 420 to a user who provides validation information indicating the accuracy of those features. The user can be an operator associated with the ebook analysis system 120 (e.g., an employee of an ebook distributor or an end user, depending on the specific embodiment. In one embodiment, the validation module 430 presents features of particular interest to the user, such as those with relatively low probabilities of being correct, or those that are considered particularly important (e.g., the identity of the main character). The validation module 430 then prompts the user to confirm the accuracy of the presented predicted features. For example, the validation module 430 might display a portion of the ebook on a screen with a predicted feature highlighted (e.g., a portion of text predicted to correspond to a particular character presented as underlined or with a colored highlight applied). The validation module 430 also provides two controls, one to confirm the prediction as correct and one to indicate that the prediction is incorrect. Thus, the validation information is a binary indication of whether the prediction was correct or incorrect. In other embodiments, the validation module 430 provides further controls to enable the user to provide additional validation information indicating how or why the prediction is incorrect, or provide corrected feature information. For example, in the case where a feature is correctly identified but the location is inaccurate, the validation module 430 might enable the user to “drag and drop” start and end markers over an image of the ebook to more accurately reflect the feature's location. As another example, if the user indicates a character has been identified incorrectly, the validation module 430 might provide a drop down menu of all characters known to be in the ebook and prompt the user to select the correct one, or indicate that the character is one previously unknown to the system.

In embodiments that use a machine learning model, the validation module 430 updates the model used to generate the predictions based on the validation information provided by the user. In one such embodiment, the validation module 430 uses a backpropagation algorithm and gradient descent method similar to that described above with reference to the machine learning module 420 to update the model. In another embodiment, the validation module 420 provides negative examples (i.e., portions of the ebook content confirmed to not include a feature that was previously predicted) to the machine learning module 420, which uses these negative examples for further training. In other words, the machine learning module 420 can also build the model based on ebook content known not to contain certain features.

In embodiments where the feature was identified using crowdsourcing, the validation module 430 determines whether the validation information should override the earlier crowd-sourced information. In one such embodiment, where the validation information is provided by an operator of the ebook analysis system 120, the validation information automatically overrides the crowd-sourced information. In another embodiment, where the validation information is provided by end users (i.e., it is also crowd-sourced), the validation module 430 keeps a record of the amount of validation information indicating a feature is incorrectly identified. If this amount exceeds a threshold relative to the amount of crowd-sourced information indicating the feature is present, the validation module 430 removes the feature (e.g., by deleting it from the metadata associated with the ebook content stored in the generated metadata store 440).

The generated metadata store 440 includes one or more computer-readable storage media that store the metadata generated for ebooks. In one embodiment, the generated metadata store 440 is a hard drive within the ebook analysis system 120. In other embodiments, the generated metadata store 440 is located elsewhere, such as at a cloud storage facility or as part of the ebook corpus 110.

FIG. 5 illustrates one embodiment of the ebook distribution system 130. As shown, the ebook distribution system 130 includes a user interests module 510, an ordering module 520, a packaging module 530, and a user profile store 540. Other embodiments of the ebook distribution system 130 include different or additional components. In addition, the functions may be distributed among the components in a different manner than described herein. For example, the user interests module 510 might be omitted, with personalization of supplemental content being performed at the reader devices 180, or not at all.

The user interests module 510 predicts what features of an ebook will be of interest to a given user. In various embodiments, the user creates a user profile for the ebook distribution system 130 (e.g., stored in the user profile store 540). The user provides a user name and indicates interests. In one embodiment, the user is presented with a list of possible interests that correspond directly to types of features (e.g., romantic scenes, strong female characters, review questions, plot twists, etc.) and selects those that apply. For example, if the user indicates an interest in strong female characters and the ebook's main character is a female detective, supplemental content relating to that character is likely to be of interest. In another embodiment, the user provides more general information about interests (e.g., romance novels, science, sports, etc.) and the user interests module 510 infers what features are likely to be of interest based on this information. For example, if the user is interested in sports, an upcoming scene set in a famous stadium is likely to be of interest to the user. Similarly, if the user is interested in romance novels, an upcoming romantic scene is likely to be of interest, even if the ebook is not itself a romance novel. In one embodiment, some genres may have types of features that are specific to that genre. For example, romance novels may have a “steamy scene” feature type, while mystery novels might have a “clue” feature type, etc. One of skill in the art will recognize other correlations and methods of determining correlations between interests and features.

In one embodiment, the user interests module 510 updates the user's interests over time based on feedback. When the user is presented with supplemental content, the user is also given an opportunity to provide feedback on the supplemental content (e.g., as described in greater detail with reference to FIG. 6). Based on the feedback, the user's profile is updated to better represent the user's true interests. For example, if the user indicates approval of supplemental content notifying the user of an upcoming romantic scene, the interest of the user in romantic scenes is strengthened. Conversely, if the user responds negatively to the notification, the user's interest in romantic scenes is weakened or removed entirely.

The ordering module 520 provides an interface with which a user can obtain ebooks and supplemental content metadata. In one embodiment, the user directs a reader device 180 to connect to the ordering module 520 via the network 170 (e.g., by providing a URL). The ordering module 520 provides an interface that enables the user to search the ebook corpus 110 (e.g., by title, author, genre, and the like). The user then selects an ebook to obtain and the request is passed to the packaging module 530 to package the selected ebook with supplemental content metadata indicating supplemental content to display in conjunction with ebook content. Alternatively, the ordering module 520 may provide the ebook content directly to the reader device 180 with the supplemental content metadata being provided separately. In one embodiment, the user can select whether or not to receive supplemental content metadata. If the user elects to not receive the metadata, the user can later download it separately.

The packaging module 530 creates a packaged ebook (e.g., an EPUB file, such as one conforming to the EPUB Region-Based Navigation 1.0 standard) that includes ebook content and supplemental content metadata. The supplemental content metadata is generated from the features identified by the ebook analysis system 120. In one embodiment, the supplemental content metadata includes a list of features and corresponding locations that the user interests module 510 predicts will be of interest to the user. In another embodiment, the supplemental content metadata includes specific instructions to display information about upcoming content in the margins of the ebook. For example, the supplemental content metadata might instruct the reader device 180 to display “Your favorite character returns in five pages!” in the margin five pages before the next passage mentioning a particular character that the user interests module 520 predicted to be a favorite of the user. In a further embodiment, the supplemental content metadata includes the identity and location of all of the features identified by the analysis system 120. This results in a larger amount of data being transferred to the reader device 180 and places greater processing demands on it, but it allows the supplemental content displayed to the user to be dynamically determined. Thus, if the user provides feedback, what supplemental content is displayed in future can be immediately adjusted without requiring additional data to be exchanged with the ebook distribution system 130. What supplemental content is displayed can even be updated when the reader device 180 is disconnected from the network 170.

The user profile store 540 includes one or more computer-readable media that store profiles of users of the ebook distribution system 130. In one embodiment, the user profiles include a username and user interests. In another embodiment, the user profiles also include a reading speed for the user, such as an average number of words read per minute. The reading speed can be provided by the user or based on how fast the user has previously progressed through ebooks. A user may have different reading speeds for different types of ebook. For example, users typically read works of fiction faster than textbooks, and thus a corresponding reading speed for each might be stored. One of skill in the art will recognize other information that may be included in the user profiles.

Further to the descriptions above, the user may be provided with controls allowing the user to make an election as to both if and when systems, programs, or features described herein may enable collection of user information (e.g., information about the user's interests). The user may also be provided with controls allowing the user to control whether content or communications are sent from a server (e.g., the ebook distribution system 130) to the user's reader device 180. Thus, the user may have control over what information is collected about the user, how that information is used, and what information is provided to the user.

FIG. 6 illustrates one embodiment of a reader device 180. As shown, the reader device 180 includes a display module 610, a feedback module 620, and a local data store 630. Other embodiments of the reader device 180 include different or additional components. In addition, the functions may be distributed among the components in a different manner than described herein. For example, in some embodiments, the feedback module 620 is omitted.

The display module 610 presents ebook content to a user as well as supplemental content based on the supplemental content metadata with which it was packaged. In some embodiments, the supplemental content metadata includes a list of features that the user interests module 510 determined are likely to be of interest to the user. The display module 610 displays portions of the ebook (e.g., pages) to the user. As the user proceeds through the ebook, the current reading position is stored. For example, the display module 610 might store the current page that is displayed or use gaze tracking to determine the most recent word read.

When the current reading position approaches the location of a feature of interest, the display module 610 displays a notification that the reader is approaching the feature. In various embodiments, the notification is displayed in a margin. In one embodiment, when the current reading position is a predetermined distance before the feature (e.g., five pages, two hundred words, etc.), the notification is displayed and remains displayed until the current reading position reaches the beginning or end of the feature (or a predetermined amount before or after these locations). The notice may wholly or partially identify the feature (e.g., “character X returns in five pages” or “a plot twist is coming up”) or may just indicate something of interest is approaching (e.g., “Keep going! It's about to get good!”). In another embodiment, the notice includes a countdown indicating the distance remaining to the feature (e.g., the number of pages remaining until the feature). In other embodiments, a larger set of features is provided to the display module 610 that includes both features of interest and features not of interest to the user. The display module 610 determines which ones to notify the reader of (e.g., using a similar approach as described above with reference to the user interests module 510).

In one embodiment, instead of expressing a distance to the feature, the display module instead presents a time. This time is calculated by dividing the distance remaining by a reading speed for the user. The reading speed can be stored as part of the user's profile or determined dynamically based on the pace at which the user has been reading the ebook. For example, if the user just completed page one hundred and has so far spent two hundred minutes reading the ebook, the reading speed is two minutes per page. Because different books are read at different speeds (e.g., because of different sized pages, different font sizes, and different complexity of content), this can provide a more accurate measure of the time it will take the reader to reach the feature in some instances.

In another set of embodiments, the user is notified of upcoming features with visual or audio indicators instead of or as well as by text in a margin. When the user reaches a point a predetermined amount before the feature (e.g., six pages), a visual or audio indicator begins to be presented at a low intensity (e.g., volume, color intensity, speed of an animated loop, number or size of a visual icon, etc.). As the user gets closer to the feature, the intensity gradually increases. For example, when the user gets within four pages of a romantic scene, a heart might appear in the margin beating slowly. As the romantic scene gets closer, the heart begins to beat faster and faster until the scene is reached. Alternatively, the number of hearts appearing in the margin might increase as the scene approaches. Similarly, the margin or background of the ebook might begin to gain a pink hue that slowly intensifies into red as the scene approaches. As another example, as the user approaches a shock in a horror ebook, a background sound effect (e.g., footsteps, a monster breathing, ghostly whispering, etc.) might start to play. As the shock gets closer, the sound effect gets gradually louder. Thus, the tension and anticipation for the upcoming feature increases.

The inclusion of supplemental content metadata that identifies features of interest in an ebook novel also enables automatic indexing with a high degree of precision. For example, in one embodiment, the display module 610 provides an index panel that indicates every appearance of a given character (e.g., the user's favorite) in the ebook and enables quick navigation (e.g., by clicking on a particular index entry) to each instance. In another embodiment, the display module 610 provides an automatic index that the user can search based on one or more fields. For example, if the user wants to find all passages where two characters interact, the user can enter each character as a search term and the display module 610 will provide a list of possible passages (assuming any exist).

The feedback module 620 provides an interface with which the user can provide feedback regarding the supplemental content. In various embodiments, when a notification of an upcoming feature is presented, a pair of buttons is presented to enable the user to request more or less of the corresponding type of supplemental content. In one such embodiment, the generality of what is considered to be the corresponding type of supplemental content depends on the feature identified. For example, if the notification relates to an appearance of the user's favorite character, the type might be as specific as appearances of that character. In contrast, if a notification of an upcoming appearance by a character was provided because of the characteristics of that character (e.g., strong female lead, detective, super villain, etc.), then supplemental content regarding any other character of that type might be considered to be of the same type. In another embodiment, controls are provided to enable the user to indicate whether they like or dislike the supplemental content due to the specific feature (e.g., I am not interested in this specific character) or the type of feature (e.g., I like characters of this type). In a further embodiment, the user is provided with controls to rate the supplemental content (e.g., on a scale of one to five).

Regardless of the specific manner in which the feedback is provided, it is used to inform what supplemental content is provided in the future. In one embodiment, the supplemental content metadata is updated locally so that if the user reads the ebook again, any notifications that were not of interest are not shown and additional notifications of types the user finds interesting are provided (if the metadata identifying such features is available). In another embodiment, the feedback module 620 sends the feedback to the ebook distribution system 120, which uses it to update the user's profile so that the user interest's module 510 can better predict the user's interests. In embodiments where all of the available metadata identifying features of the ebook is not provided to the reader device 180, the feedback module 620 requests updated supplemental metadata either in response to the user providing feedback or at periodic intervals (e.g., weekly).

The local data store 630 is one or more computer-readable media that store the display software, ebook content, and supplemental content metadata. In one embodiment, the user downloads packaged ebooks that include the supplemental content metadata to the local data store 630. The presentation module 610 then accesses the packaged ebook from the local data store 630. In another embodiment, the packaged ebook is stored remotely (e.g., at a cloud server) and the display module 610 accesses it via the network 170.

### Example Method

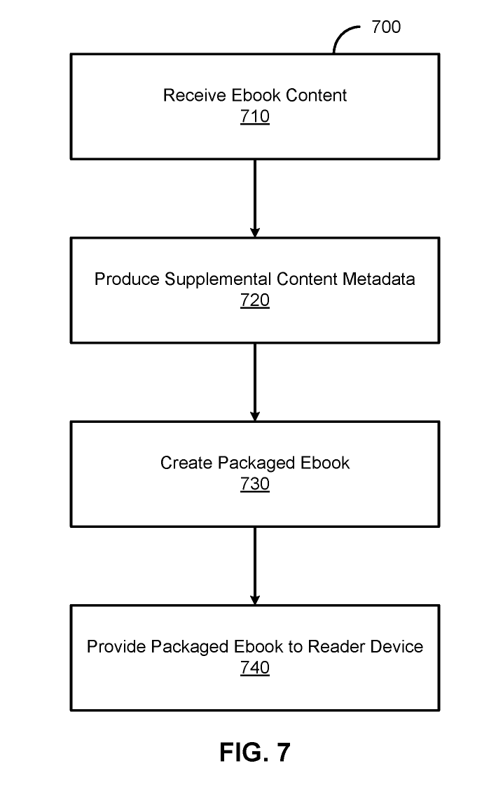

FIG. 7 illustrates one embodiment of a method 700 of providing ebook content and supplemental content metadata to a reader device 180. FIG. 7 attributes the steps of the method 700 to the ebook distribution system 130. However, some or all of the steps may be performed by other entities. In addition, some embodiments may perform the steps in parallel, perform the steps in different orders, or perform different steps.

In the embodiment shown in FIG. 7, the method 700 begins with the ebook distribution system 130 receiving 710 ebook content. The ebook content is the text (or other content) for a book (or part thereof). In one embodiment, the user selects an ebook to download and the ebook distribution system 130 obtains the corresponding content from the ebook corpus 110. Alternatively, the ebook content may already be stored locally in the ebook distribution system 130.

The ebook distribution system 130 produces 720 supplemental content metadata. In one embodiment, the supplemental content metadata is a list of features that are predicted to be of interest to the user along with the corresponding locations in the ebook content. In another embodiment, the supplemental content metadata indicates the location of features of interest as specific instructions to display a notification that the feature is upcoming a predetermined distance before the feature appears in the ebook content. For example, the supplemental content metadata might include an instruction to display “Your favorite character returns in five pages” in the margin of page seventy when the next appearance of that character is on page seventy-five.

The ebook distribution system creates 730 a packaged ebook including the ebook content and the supplemental content metadata. The packaged ebook is provided 740 to the reader device 180. The reader device 180 presents the ebook content to the user. The reader device 180 also presents a notification as the current reading position within the ebook content approaches the location of a feature of interest (as indicated by the supplemental content metadata). As described previously, this notification can take the form of text in a margin, a change in background color, a sound effect, an animation, or the like. In some embodiments, an intensity of the notification (e.g., a volume level, animation loop rate, color intensity, or the like) increases as the distance between the current reading position and the location of the feature decreases.

### ADDITIONAL CONSIDERATIONS

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and process for providing indexed ebook annotations. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein. The scope of the invention is to be limited only by the following claims.

What is claimed is:

1. A computer-implemented method of providing digital content to an electronic device, the method comprising:
receiving digital content;
producing supplemental content metadata indicating a location of a feature in the digital content that is predicted to be of interest to a user;
creating a digital content package including the digital content and the supplemental content metadata; and
providing the digital content package to the electronic device for presentation of the digital content in conjunction with a notification that a current position in the digital content is approaching the location of the feature.

2. The method of claim 1, further comprising:
obtaining feature metadata identifying a location of each of a plurality of features in the digital content;
predicting a subset of the plurality of features that are likely to be of interest to a user based on a corresponding user profile, the feature being one of the subset.

3. The method of claim 2, wherein the feature metadata is obtained by:
applying a machine-learning model to the digital content, the machine learning model identifying a plurality of predicted features, each predicted feature including an identity of the predicted feature, a location of the predicted feature, and a corresponding probability that the predicted feature is present at the location; and
including a predicted feature in the plurality of features if the corresponding probability exceeds a threshold.

4. The method of claim 1, wherein predicting the subset of the plurality of features that are likely to be of interest comprises:
predicting an interest of the user based on the corresponding user profile; and
including a feature in the subset responsive to a correspondence between the interest and a type of the feature.

5. The method of claim 1, wherein the digital content is ebook content and the notification includes text displayed in a margin indicating a distance between the current position and the location of the feature.

6. The method of claim 1, wherein the notification includes a visual indicator having an intensity, the intensity increasing as the current position gets closer to the location of the feature.

7. The method of claim 6, wherein the visual indicator is a looped animation and the intensity is a rate at which the animation loops, the animation looping faster as the current position gets closer to the location of the feature.

8. A system for providing digital content to an electronic device, the system comprising:
a non-transitory computer-readable storage medium storing executable computer program code including instructions for:
receiving digital content;
producing supplemental content metadata indicating a location of a feature in the digital content that is predicted to be of interest to a user;
creating a digital content package including the digital content and the supplemental content metadata; and
providing the digital content package to the electronic device for presentation of the digital content in conjunction with a notification that a current position in the digital content is approaching the location of the feature; and
one or more processors for executing the computer program code.

9. The system of claim 8, wherein the executable computer program code further includes instructions for:
obtaining feature metadata identifying a location of each of a plurality of features in the digital content;
predicting a subset of the plurality of features that are likely to be of interest to a user based on a corresponding user profile, the feature being one of the subset.

10. The system of claim 9, wherein the feature metadata is obtained by:
applying a machine-learning model to the digital content, the machine learning model identifying a plurality of predicted features, each predicted feature including an identity of the predicted feature, a location of the predicted feature, and a corresponding probability that the predicted feature is present at the location; and
including a predicted feature in the plurality of features if the corresponding probability exceeds a threshold.

11. The system of claim 8, wherein predicting the subset of the plurality of features that are likely to be of interest comprises:
predicting an interest of the user based on the corresponding user profile; and
including a feature in the subset responsive to a correspondence between the interest and a type of the feature.

12. The system of claim 8, wherein the digital content is ebook content and the notification includes text displayed in a margin indicating a distance between the current position and the location of the feature.

13. The system of claim 8, wherein the notification includes an animation that loops at a rate, the rate increasing as the current location gets closer to the location of the feature.

14. A non-transitory computer-readable storage medium storing executable computer program code for providing digital content to an electronic device, the computer program code comprising instructions for:
receiving digital content;
producing supplemental content metadata indicating a location of a feature in the digital content that is predicted to be of interest to a user;
creating a digital content package including the digital content and the supplemental content metadata; and
providing the digital content package to the electronic device for presentation of the digital content in conjunction with a notification that a current position in the digital content is approaching the location of the feature.

15. The non-transitory computer-readable storage medium of claim 14, wherein the computer program code further comprises instructions for:
obtaining feature metadata identifying a location of each of a plurality of features in the digital content;
predicting a subset of the plurality of features that are likely to be of interest to a user based on a corresponding user profile, the feature being one of the subset.

16. The non-transitory computer-readable storage medium of claim 15, wherein the feature metadata is obtained by:
applying a machine-learning model to the digital content, the machine learning model identifying a plurality of predicted features, each predicted feature including an identity of the predicted feature, a location of the predicted feature, and a corresponding probability that the predicted feature is present at the location; and
including a predicted feature in the plurality of features if the corresponding probability exceeds a threshold.

17. The non-transitory computer-readable storage medium of claim 14, wherein predicting the subset of the plurality of features that are likely to be of interest comprises:
predicting an interest of the user based on the corresponding user profile; and
including a feature in the subset responsive to a correspondence between the interest and a type of the feature.

18. The non-transitory computer-readable storage medium of claim 14, wherein the digital content includes ebook content and the notification includes text displayed in a margin indicating a distance between the current position and the location of the feature.

19. The non-transitory computer-readable storage medium of claim 14, wherein the notification includes a visual indicator having an intensity, the intensity increasing as the current position gets closer to the location of the feature.

20. The non-transitory computer-readable storage medium of claim 19, wherein the visual indicator is a looped animation and the intensity is a rate at which the animation loops, the animation looping faster as the current position gets closer to the location of the feature.
